(19) United States
(12) Patent Application Publication
(10) Pub. No.: US 2006/0198979 A1
(43) Pub. Date: Sep. 7, 2006

(54) Adhesive printing material assemblies and methods of use

(76) Inventors: James W. McConkie, Sandy, UT (US); Bradley H. Parker, Salt Lake City, UT (US)

Correspondence Address: JENS C. JENKINS;Workman Nydegger, 1000 Eagle Gale Tower, 60 E South Temple, Salt Lake City, UT, 84117, US

(21) Appl. No.: 11/073,833

(22) Filed: Mar. 7, 2005

(51) Int. Cl. B32B 38/14; B41J 13/24; B32B 33/00

(52) U.S. Cl. 428/42.3; 156/277; 156/247; 156/249; 400/622

(57) ABSTRACT

An adhesive printing material assembly includes a transport material and one or more adhesive printing materials that are releasably affixed to the transport material. The transport material can be a standard-sized sheet of paper that, in some instances, is a blank paper. The adhesive printing materials, such as Post-its each include an adhesive portion and a non-adhesive portion on the same side of the adhesive printing material. The adhesive portion is releasably affixed to the transport material, which enables the adhesive printing materials it to be fed through the printing device while affixed to the transport materials. After printing, the adhesive printing materials can be removed from the transport material without causing damage to either the adhesive printing materials or the transport material, thereby enabling the transport material to be reused for a subsequent and standard printing application.

### BACKGROUND OF THE INVENTION

1. The Field of the Invention

The present invention relates to the field of printing and, more particularly, to adhesive printing material assemblies and corresponding methods and systems for use.

2. The Relevant Technology

Printing, in the context of the present application, includes traditional printing, such as can be performed with traditional inkjet, laser jet and other types of printers, as well as photocopying and other known copying and printing techniques.

Modern printing technologies facilitate the ability to convey information in a professional and aesthetic manner. Accordingly, printing is commonly used in a variety of industries, including the news and advertising industries, the legal and educational industries, and many more, to produce durable publications and materials. Many personal consumers also benefit from a variety of printing applications in their own personal endeavors, hobbies and crafts.

The relative ease and affordability of printing has helped make made printing a convenience that is very much relied upon by businesses and individual consumers to disseminate and preserve information. For at least these reasons, as well as others, there has been an ongoing desire in the printing industry to improve and further advance printing applications.

Many printing advances have been directed to the printing devices themselves as well as the corresponding software used to generate the text and graphics to be printed. For example, word processing and graphics rendering software have made significant advances that improve the functionality and convenience of printing applications, thereby making it easier and more affordable for individual consumers to create, customize and reproduce a document in a desired manner.

Advances in printing are not limited, however, only to advances in hardware and software. The print materials themselves, for example, have also realized significant improvements, now providing consumers a wide variety of choices in the weights, colors, textures, sheens and transparencies of the paper and inks that are used. A variety of preprinted stationeries and templates are also available to fill a variety of specialized needs. Modern technology also enables consumers to print on envelopes, cards and materials other than standard-sized paper.

One particularly interesting advancement in the printing industry is the ability to print on adhesives, such as labels. It is possible, for example, to print text and graphics on labels before they are ultimately affixed to a final product. To facilitate printing on labels, which have an entirely adhesive backing, the labels are mounted on a non-stick material. During printing, the labels are fed through a printing device while they are affixed to the non-stick material and in such a manner that the label adhesive does not stick to or bind up the printer components.

Because the adhesive labels come with a known and preconfigured layout and on a predetermined size of paper, special software that is resident on the printing or corresponding computing devices can also be used to position and format the printed text and graphics to the specific preconfigured locations of the labels. Once the labels have been printed on, they can be removed from the transport material and affixed to another object. It is common, for example, to print mailing labels, file or folder labels, and CD labels in this manner.

One problem with printing on labels in the foregoing manner, however, is that existing labels have an entirely adhesive backing, thereby limiting their application and functionality. In particular, once the label is affixed to another material (e.g., envelope, folder, CD, and so forth), they cannot easily be removed, particularly without damaging the label and/or the other material.

Another known problem with printing on labels is waste. In particular, once all of the labels from a manufactured label sheet have been printed on or otherwise used and removed, the non-stick sheet or material that remains represents waste insofar as does not provide any useful functionality for the consumer and is typically discarded. The primary reason for this is because the non-stick material it is not a particularly useful or desirable printing material.

Many adhesive label sheets also include precut or perforated labels that are laid out with a particular configuration that improves the ease of removing the labels, but that increases the difficulty of using the entire product, particularly when labels have a shape that is not rectilinear. For example, once the labels have all been printed on and removed from a sheet, it is common for the adhesive label sheet to still contain certain amounts of residual label material that bordered the actual labels before they were removed. This residual material represents wasted resources which can drive up the cost of manufacturing the labels. This waste can also have a negative impact on the environment when it is discarded.

Accordingly, because of the foregoing limitations with printing on labels, many printing applications for which adhesive materials could be utilized are not. For example, labels or other adhesive materials are typically not used to print notes or other clarifying text or graphics to be affixed to a document or other publication. One reason for this, as mentioned above, is because labels cannot easily be moved once they are affixed to a document, without damaging the label or the document. Most labels are also preconfigured for very specific application (e.g., mailing labels), such that their availability in size, color and shape is very limited. The relative cost that is associated with purchasing labels for general and alternative printing applications is yet another concern for using labels for anything other than the specific printing application for which they are made (e.g., to print mailing labels, CD labels, and so forth).

In view of the forgoing, there is need for improved adhesive printing materials as well as improved systems and methods for printing thereon.

### BRIEF SUMMARY OF CERTAIN EMBODIMENTS OF THE INVENTION

The present invention generally relates to improved adhesive printing material assemblies and methods, systems, and corresponding computer program products for their use.

In one embodiment of the invention, an adhesive printing material assembly is provided that includes a transport material and one or more adhesive printing materials that are releasably affixed to the transport material. The transport material can be a standard-sized sheet of paper, such as a standard letter-sized paper, A4 or any other paper. In some instances, the transport material is a blank sheet of paper. In other instances, the transport material includes a template or other printed material.

The adhesive printing materials, such as, but not limited to Post-its® each include an adhesive portion and a non-adhesive portion on the same side of the adhesive printing material. The adhesive portion is releasably affixed to the transport material, which enables the adhesive printing materials it to be fed through the printing device while still affixed to the transport materials.

In some embodiments, the adhesive portion of the inventive material assemblies is also releasably affixable to a plurality of other objects, in addition to the transport materials, such as, but not limited to standard paper, and without causing damage or significant damage to the objects (e.g., paper) or adhesive printing materials. It should be appreciated that in this embodiment, the adhesive printing materials are clearly distinguished from labels that would cause damage and are not configured to be releasably affixable to a plurality of other objects, such as paper, as described above.

After printing, the adhesive printing materials are removed from the transport material and releasably affixed to another object or material and without causing damage to either the adhesive printing materials or the transport material. The transport material can then be reused for a subsequent and/or standard printing application.

In some alternative embodiments, the transport material is also configured with one or more templates, having corresponding markings for positioning new adhesive printing materials to the transport material to enable subsequent printing applications with new adhesive printing materials that are affixed to the transport material according to the layout of the template(s).

The adhesive printing material can include any size or shape. The shapes can include rectilinear shapes as well as non-rectilinear shapes. In some embodiments, the size of the printing material is small enough to enable a plurality of different adhesive printing materials to be releasably affixed to a single transport material. The adhesive portion can also have different sizes and shapes, which may or may not correspond to the general size and shape of the printing material. The adhesive portion of the printing material can also be larger or smaller than the non-adhesive portion, depending on the needs and preferences of the user.

In summary, the present invention provides new and improved adhesive printing material assemblies and the use thereof. These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates one embodiment of an adhesive printing material assembly that includes a transport material and a plurality of differently configured adhesive printing materials;

FIG. 2 illustrates one embodiment of a transport material for an adhesive printing material assembly that includes various configurations of templates printed thereon; and

FIG. 3 illustrates a flowchart corresponding to various methods of the invention for printing adhesive printing materials.

### DETAILED DESCRIPTION OF THE PREFERRED EMBODIMENTS

As mentioned above, the present invention generally relates to improved printing materials and, more particularly, to improved adhesive printing material assemblies, as well as corresponding methods, systems, and corresponding computer program products for performing printing applications therewith.

The improved adhesive printing material assemblies provided by the invention facilitate new and useful printing applications, such as printing on adhesive materials other than labels. In one embodiment, the printing of adhesive materials such as Post-its® and other adhesive printing materials having an adhesive portion, as well as a non-adhesive portion, and which are releasably affixed to a transport material.

According to one embodiment, the adhesive printing materials are assembled with a transport material, such as a standard sheet of paper. The adhesive printing materials are then releasably affixed to the transport material and fed through a printing device to perform a printing application. A user can assemble the adhesive printing material and the transport material or, alternatively, can obtain the adhesive printing material assemblies already preassembled from a third party source.

After being printed on, the Post-it® or other adhesive printing material can then be removed from the transport material and affixed to another document or object and without causing damage to either the adhesive printing materials or the transport material. In this manner, the transport material can then be reused for a subsequent printing application, unlike the backing material for labels.

In the description that follows, some embodiments of the invention are described using a flowchart and/or are described generally in the context of computer program products or software. Such descriptions, however, should not be construed as limiting the scope of the invention. Instead, such descriptions are merely intended to illustrate some of the exemplary embodiments of the present invention.

It should also be appreciated that the methods described herein can be practiced with the use of a special purpose or general purpose computer comprising various computer hardware, including printing devices. Accordingly, embodiments within the scope of the present invention include computer-readable media having computer-executable instructions or data structures stored thereon. Such computer-readable media can be any available media which can be accessed by a general purpose or special purpose computer or printing device. By way of example, and not limitation, such computer-readable media can comprise RAM, ROM, EPROM, CD-ROM or other optical disk storage, magnetic disk storage or other magnetic storage devices, or any other medium which can be used to store the desired executable instructions or data structures and which can be accessed by a general purpose or special purpose computer or printing device.

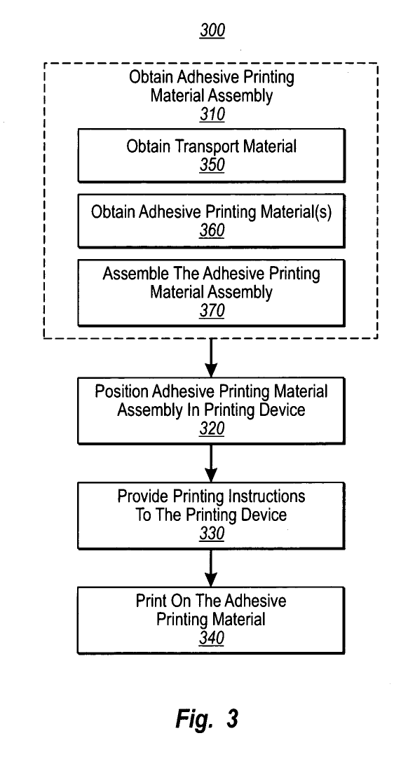

Computer-readable media may also include remote data stores such as web servers and other remote data stores. When information is transferred or provided over a network or other communications connection to a computer or printing device, the computer or printing device properly views the connection as a computer-readable medium. Thus, such a connection is also properly termed a computer-readable medium. Combinations of the above should also be included within the scope of computer-readable media. Computer-executable instructions comprise, for example, instructions and data which cause a general purpose computer, special purpose computer, printing device or other special purpose processing device to perform a certain function or group of functions. The computer-executable instructions and associated data structures represent an example of program code means for executing the steps and acts of the invention as illustrated in the flowchart of FIG. 3 and as further disclosed throughout the following specification.

Although not required, the invention can also be described in the general context of computer-executable instructions, such as program modules, being executed by one or more processors included, for example, in a printing device or network that includes one or more computing and printing devices. Generally, program modules include routines, programs, objects, components, data structures, etc. that perform particular tasks or implement particular abstract data types.

As used herein, the terms “print” and “printing application” refer to standard printing applications in which text and/or graphics are reproduced on a “printing material,” wherein “printing material” is defined as a paper sheet, a plastic sheet or film fabric, or any other material that can be printed on. Similarly, “printing devices” can include any traditional or non-traditional printer and/or copier configured to perform, a printing application.

The term “transport material” is used herein to describe a printing material such as, but not limited to, a sheet of paper that an adhesive printing material can be releasably affixed to, as described herein, and that can be used in a subsequent printing application. According to some embodiments, the transport material is described as a standard or standard-sized paper. A “standard-sized” paper, in this context, can include any sized paper having a size that can be recognized by printing devices and corresponding printing application software. Non-limiting examples of some standard-sized paper include standard-sized letter paper (8.5 inches by 11 inches), and standard-sized ISO A4 paper.

The term “adhesive printing material,” as defined herein, can be any printing material having at least one adhesive portion over which an adhesive material is disposed and that also includes at least one non-adhesive portion on the same side of the printing material as the adhesive portion. Accordingly, standard mailing labels having a side that is entirely covered with an adhesive, but no non-adhesive portion, do not qualify as an adhesive printing material according to the scope of the present application and claims. However, Post-it® notes, Post-it® pad papers, Post-it® easel papers, Post-it® flags, and many Post-it® labels do qualify as “adhesive printing materials,” as do other adhesive printing materials having both an adhesive portion and a non-adhesive portion disposed on the same side of the printing material. In many embodiments, the adhesive portion of the adhesive printing material is also configured with means so as to be releasably affixable to paper and other objects.

Adhesive Printing Material Assembly

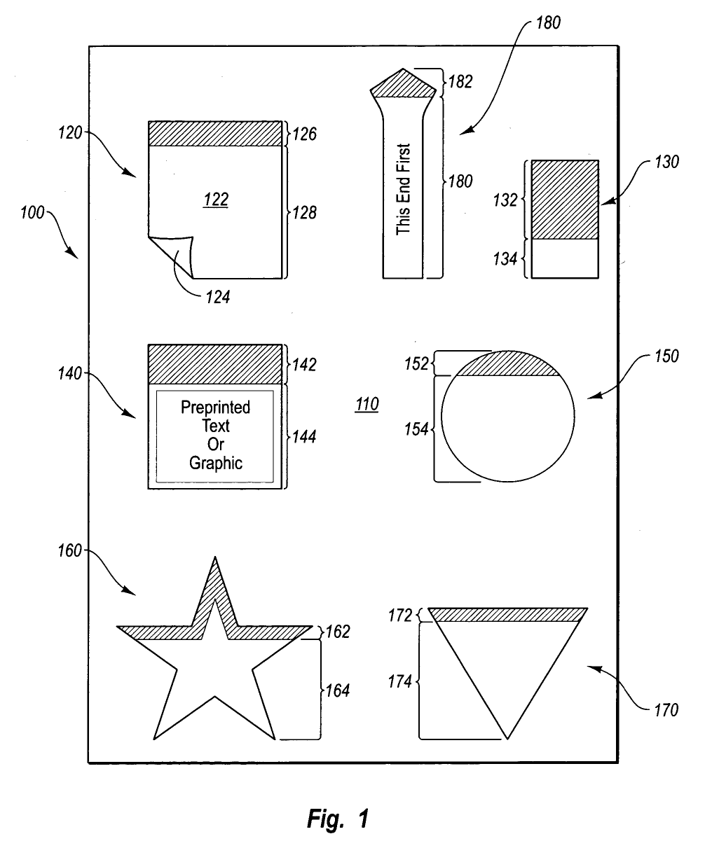

Attention will now be directed to FIG. 1, which illustrates one example of an adhesive printing material assembly 100. As shown, the assembly 100 includes a transport material 110 and one or more adhesive printing materials 120, 130, 140, 150, 160, 170 that are each releasably affixed to the transport material 110. The term “releasably affixed”, in this context, suggests the adhesive printing materials can be removed without causing any noticeable and/or substantial damage to the transport material 110 or the adhesive printing materials 120, 130, 140, 150, 160, 170. In fact, it is intended for the adhesive printing materials 120, 130, 140, 150, 160, 170 to be removed from the transport material 110 after they are printed on.

In some embodiments, it is also intended that the adhesive printing materials 120, 130, 140, 150, 160, 170 be releasably affixed to another object, such as a document, a text book, or other printed material after they have been utilized in a printing application. In this regard, as recited in the claims, it will be appreciated that the adhesive printing materials utilized by the present invention include means for releasably adhering to a transport material (described below) and/or to one or more other objects. Such means for releasably adhering can include an adhesive, glue, tape, or other substance, for example, that is affixed to the adhesive printing material.

According to one embodiment, the adhesive printing materials comprise one or more types of Post-it®, which are product of 3M, having corporate headquarters in St. Paul, Minn. It will be appreciated, however, that the invention is not only limited to adhesive printing assemblies that include Post-it®, but also extends to adhesive printing assemblies that include other types of adhesive printing materials having both an adhesive portion and a non-adhesive portion on the same side of the printing material.

As shown in FIG. 1, each of the adhesive printing materials includes a top side or surface and a bottom side or surface. This is clearly shown with the adhesive printing material 120, which is slightly folded back to illustrate both its top side 122 and, its bottom side 124. As mentioned above, each of the adhesive printing materials 130, 140, 150, 160, 170 also includes an adhesive portion (126, 132, 142, 152, 162, 172, respectively) comprising an adhesive that is configured to releasably affix to the transport material 110 and one or more other objects. Cross-hatch shading is provided in the present illustration to show how the adhesive portions (126, 132, 142, 152, 162, 172) can have different configurations. It will be appreciated, however, that the adhesive portions are typically not visible from this view, and are therefore shown only as cross-hatching in the present figure to illustrate their relative positions and configurations.

It will also be appreciated that while the adhesive portion of each of the adhesive printing materials shown in FIG. 1 are positioned towards the top of the page (transport material 110), this is not necessary. Likewise, the adhesive portions (126, 142, 152, 162, 172) do not necessarily need to comprise a smaller relative size than the corresponding non-adhesive portions (128, 144, 154, 164, 174). In fact, as shown with material 130, the non-adhesive portion 132 can sometimes be smaller than the adhesive portion 132. This embodiment might be useful, for example, when the adhesive material comprises a Post-it® flag.

Although it may be desirable to provide adhesive printing material assemblies with only blank adhesive printing materials, it is also possible to provide adhesive printing material assemblies having adhesive printing materials that are already printed on, as shown with printing material 140.

In some embodiments, for example, a manufacturer or third party can take the adhesive printing material assemblies of the present invention and print any type and amount of text and/or graphics on the adhesive printing materials, to provide modified adhesive printing materials to consumers for purchase. These modified materials can be useful, for example, when a publisher or other distributor prints explanatory notes, lesson materials, words in a foreign language, educational materials, graphics, or any other content on the adhesive printing materials that a consumer can remove at their own leisure and to attach to books, lesson sheets, other publications, or other objects to provide additional insight, clarity or for any other reason. Because of the unique characteristics of the present invention, the adhesive printing materials can then be removed and releasably adhered to different objects without having to worry about damaging the objects or the printed materials. The non-adhesive portion of the adhesive printing materials also provides the functionality of making the printed materials easy to grip and remove or reposition, as desired.

As further illustrated by FIG. 1, the adhesive printing materials 120, 130, 140, 150, 160, 170 can have different shapes and sizes. Likewise, the adhesive portion 126, 132, 142, 152, 162, 172 of these printing materials 120, 130, 140, 150, 160, 170 can also have different shapes and sizes, some of which may conform to the general shape of the adhesive printing material, while others may not.

To facilitate the printing of the adhesive printing materials in such a way that they don't stick to or bind up the components of a printing device, it is sometimes desirable to arrange the adhesive printing materials in the same general alignment with respect to the transport material 110. When the printing materials are all aligned, the adhesive printing material assembly 100 can be placed within a printer with a leading edge of the assembly and in such a manner that the adhesive portions of the different printing materials enter the printer prior to the non-adhesive portions. As will be appreciated, this helps to prevent the adhesive printing materials from becoming dislodged from the assembly during the printing procedure and from sticking to and/or binding the components of the printing device.

It will be appreciated that any number of adhesive printing materials can be aligned on the transport material. In fact, in some embodiments, only a single adhesive printing material is used in the assembly, which can be any size and shape. In some instances, the adhesive printing material can be the same shape and size as the transport material. In other instances, the adhesive printing material is smaller than the transport material.

Instructions can also be provided to help assist a consumer knowing which direction to feed the assembly 110. The instructions can be provided as text, images or aniy combination thereof. In one embodiment, to preserve the cleanliness of the transport material 110, the instructions can be printed on a removable label or printing material such as material 180. After performing a printing procedure with the assembly, the adhesive printing materials 120, 130, 140, 150, 160, 170 can then be manually removed, as can material 180, having its own adhesive and non-adhesive portions (182, 184), and releasably affixed to another object or material and without causing damage to either the adhesive printing materials or the transport material 110 and in such a way that the transport material 110 can then be used for a subsequent printing procedure, by its self or with other adhesive printing materials, as will now be described.

Transport Material

The transport material 110 can preferably, although not necessarily, comprise a standard-sized sheet of paper, such as a standard letter-sized paper, A4 or other-sized paper. In some instances, the transport material is a blank sheet of paper which can be printed on in a standard printing application or otherwise reused after printing on the adhesive printing materials. In this regard, it will be appreciated that the present invention provides a significant advantage over known techniques for printing on labels and other adhesives, wherein the transport material is of little use other than to carry the labels for printing and in which the transport material is subsequently disposed of, either alone or with unused border portions of the labels.

As mentioned above, the transport material can also include a printed template, such that new adhesive printing materials can be affixed to the transport material repeatedly and in subsequent printing applications, according to the instructions or layout of the template, which helps to ensure correct placement, and to enable printing of the newly placed adhesive printing materials. In this manner, the transport material can itself help instruct a user how to create the adhesive printing material assemblies of the present invention for initial use or for recycled use.

In some embodiments, a user obtains a preprinted template separately from the adhesive printing materials, and thereafter creates a printing assembly of the invention with these components. A user can also obtain a template from a previous assembly, once the adhesive printing materials are used: and/or removed, thereby effectively recycling the template for subsequent use. Accordingly, a template can be reused numerous times to print on numerous different adhesive printing materials in multiple different printing procedures thereby overcoming many of the problems associated with waste described above in regard to known techniques for printing on labels. When the transport material is blank, without any template, the transport material can also be used in a subsequent standard printing application, also overcoming the problems with waste known in the art of printing on labels.

In some instances, the templates are obtained by the consumer in a preprinted format. In other instances, a user can create the template from a blank sheet of paper or a partially completed template form. Printing instructions for creating or finalizing a template can be created by a user with software applications, such as, but not limited to standard word processing and spreadsheet software (e.g., Word, Excel, WordPerfect, and so forth). A user can also download templates from a third party source or computer-readable media. This embodiment is particularly useful when the printing materials have non-rectangular or irregular shapes that are not easy to map or arrange with standard word processing and spreadsheet software. In this regard, providing electronic copies of templates corresponding to placement of the adhesive printing materials, prior to, or subsequent to their placement on the transport material, is one aspect of the invention. Once an electronic copy of the template is created, or downloaded, it can then be printed onto the paper or other transport material.

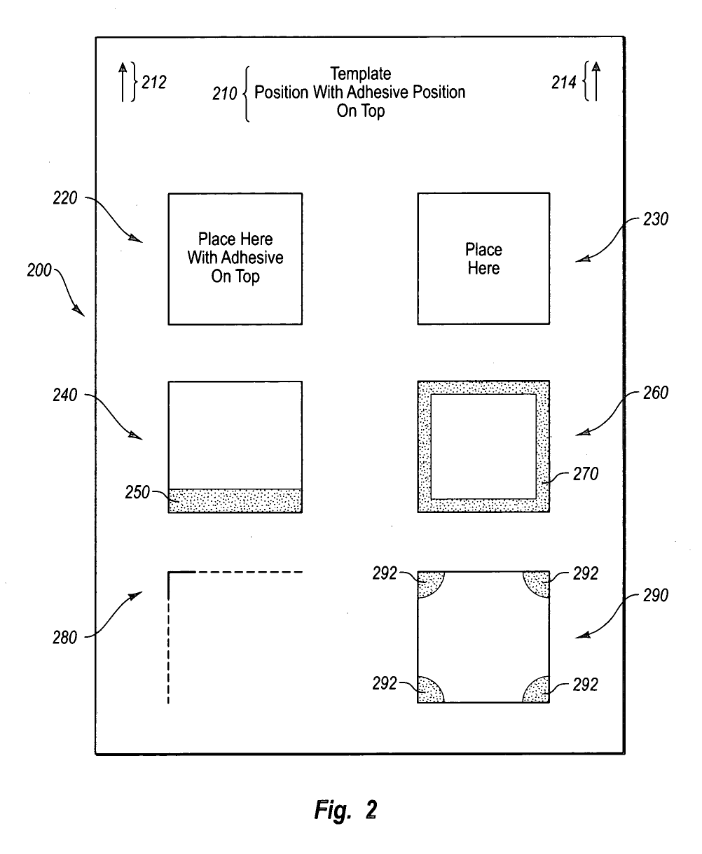

FIG. 2 illustrates one example of a template 200 with various different features that can selectively be applied to make different types of templates according to the invention. As illustrated, the template can include text with instructions (210) regarding the placement of adhesive printing materials thereto. It will be appreciated, however, that this illustrated text 210 is merely exemplary of text that can be provided and, should not therefore be construed as limiting the invention. In fact, any text and instructions can be provided to accommodate virtually any need or preference. In some instances, graphical images can also be provided as instructions, such as arrows 212 and which indicate a preferred direction for feeding the template 200 into a printing device once the adhesive printing material(s) are affixed.

Elements 220 and 230 illustrate different examples of template images, which comprise substantially square frames with different version of text instructions printed therein. It will be appreciated, however, that the shape and size of the template frames can also vary to accommodate the different shapes and sizes of the different adhesive printing materials.

Element template frames 240, 260 and 290 also illustrate different features of some templates. In these examples, the frames 240, 260 and 290 include adhesive portions 250, 270 and 292, respectively, which comprise part of the template and serve to help hold down the edges of an adhesive printing material. Such embodiments as these can be helpful when the adhesive printing material has only a small adhesive portion and when printing procedures threaten to dislodge adhesive printing materials from the template. In particular, the adhesive portions (250, 270, 292) of the transport material or template 200 can help hold an adhesive printing material substantially flat against the transport material, such as, for example, by releasably adhering to the non-adhesive portions of the printing material.

In yet another embodiment; the template may include an open edge frame, such as straight edge 280, which can accommodate different sized adhesive printing materials of the same shape.

As shown, the template may prompt a user to position the adhesive printing materials on the transport material (template) in such a way that the adhesive printing material assembly is enabled to pass through a printing device, such as a printer or copier, and without the adhesive printing material coming off of the transport material until the adhesive printing material is manually removed at a later time. For example, the template may prompt the user to position all of the adhesive portions of each corresponding adhesive printing material towards the top of the page (see elements 210 and 220, for example). It will be appreciated, however, that positioning the adhesive printing materials in this way may not be necessary when the template 200 includes its own adhesive portions 250, 270, 290 that can help hold down the adhesive printing material substantially flat, regardless of its orientation, as generally suggested above.

Although many features have been described above, with regard to both the template 200 and the adhesive printing materials (120, 130, 140, 150, 160, 170 and 180), it will be appreciated that all of the described features and elements are not necessarily present in each adhesive printing material assembly contemplated by the invention. Likewise, the foregoing features and elements should not be construed as being an exhaustive compilation of all the features and elements that can be included in the adhesive printing material assemblies of the invention. Instead, the adhesive printing material assemblies of the invention can include any combination of the foregoing features and elements, with any other additional features or elements that are desired.

Printing of an Adhesive Printing Material Assembly

Attention will now be directed to FIG. 3, which illustrates a flowchart 300 of one embodiment of a method of the invention for printing on an adhesive printing material assembly. As shown, the method includes obtaining an adhesive printing material assembly (310), positioning the adhesive printing material assembly in a printing device (320), and providing printing instructions to the printing device (330), which causes the printing device to print on the adhesive printing material as instructed (340).

In some embodiments, the printing instructions are provided (320) by first downloading or otherwise obtaining the appropriate software that recognizes the layout of a template, such as described above in reference to FIG. 2. These instructions can be provided as part of a word processing or spreadsheet application and easily selectable from a user interface, or from any other software. In other circumstances these instructions can also be created by a user using a printing device or a corresponding computing device and can thereby be provided to the printing device. The printing instructions can be provided through any wireless connection, wired connection, or through the use of a transport computer-readable media (e.g., diskette, memory card, and so forth). In some instances, the printing instructions can also be provided by a third party, such as a printing device manufacturer who installs printing instructions prior to or subsequent to selling the printing device.

The printing instructions can also comprise a plurality of different printing instructions, each having some impact on how a printing application will be performed, that are obtained from any combination of the forgoing sources.

Preferably, although not necessarily (for reasons described above), the assembly is first positioned within the printing device, during a printing application, in such a way that the adhesive portions of the printing material will enter the printing device during printing prior to the corresponding non-adhesive portions.

As further mentioned above, the adhesive printing material assembly can be obtained in a preassembled form (as a single sheet or as a plurality of sheets that are packaged together), such as provided by a third party or, alternatively, the adhesive printing material assembly can be assembled by an individual consumer. For example, the consumer can obtain a transport material (350) and an adhesive printing material (360) separately. Thereafter, the transport material and adhesive printing material can be assembled (370) into a final product, as described above. Either way, it will be appreciated that the finished adhesive printing material assemblies and corresponding methods of use facilitate the printing of adhesive materials and in such a way as to overcome many of the problems that are known with regard to printing on labels.

Once an adhesive printing material assembly is created, the corresponding adhesive printing materials can be used for a printing application, as described above, either before or after they are sold to the end consumer. In some instance, for example, the consumer prints on the adhesive printing materials. In other instances, useful text and graphics are already printed on the adhesive printing materials by the manufacturer or third party, wherein the printed content on the adhesive printing materials corresponds to content found in a separate publication (e.g., a text book, scriptures, lesson materials, educational materials, and so forth) or that corresponds to other objects that are substantially unrelated to the adhesive printing material assemblies. However, even if the adhesive printing materials are already printed on, they can be left on the transport material as a complete assembly for possible subsequent printing. The printed adhesive printing materials can also be removed and sold separately from the transport material, either alone or as part of a package with another publication or object. Accordingly, in some embodiments, publications or other materials can be sold as new assemblies that include printed adhesive printing materials that were printed in the manner described above, by the party that assembled the adhesive printing material assemblies or by another party.

The present invention may be embodied in other specific forms without departing from its spirit or essential characteristics. The described embodiments are to be considered, therefore, in all respects only as illustrative and not restrictive. The scope of the invention is, accordingly, indicated by the appended claims rather than by the foregoing description. All changes which come within the meaning and range of equivalency of the claims are to be embraced within their scope.

What is claimed is:

1. An adhesive printing material assembly comprising:
a transport material comprising a sheet of material; and
an adhesive printing material that is releasably affixed to the transport material and that includes means for releasably adhering to a separate paper material, wherein the adhesive printing material comprises:
a first side and a second side, the first side including both an adhesive portion and a non-adhesive portion, wherein the adhesive portion comprises means for releasably adhering to the transport material and for being removed from the transport material and said separate paper material without damaging the adhesive printing material, the transport material, or separate paper material, and wherein the non-adhesive portion is free of any adhesive affixed thereto, and such that the adhesive printing material is releasably affixed to the transport material by the adhesive portion.

2. An adhesive printing material assembly as recited in claim 1, wherein the transport material comprises a sheet of paper.

3. An adhesive printing material assembly as recited in claim 2, wherein the transport material comprises a reusable and blank sheet of standard-sized printer paper that remains for re-use after a printing operation is first performed on the adhesive printing material assembly in which the adhesive printing material assembly is fed through a printing device and after the adhesive printing material is removed from the adhesive printing material assembly.

4. An adhesive printing material assembly as recited in claim 2, wherein the sheet of paper comprises one of a standard letter-size paper and a standard A4-size paper.

5. An adhesive printing material assembly as recited in claim 1, wherein the transport material further comprises a template that is printed on it, at least a portion of the template corresponding specifically to a position of the adhesive printing material on the transport material.

6. An adhesive printing material assembly as recited in claim 1, wherein the adhesive portion is smaller in size than the non-adhesive portion.

7. An adhesive printing material assembly as recited in claim 1, wherein the transport material further comprises means for holding the adhesive printing material substantially flat against the transport material before, during and after a printing application in which the adhesive printing material assembly is fed through a printing device, and until the adhesive printing material is manually removed from the transport material, wherein the means for holding includes an adhesive material that is permanently affixed to the transport material and positioned to releasably adhere to the non-adhesive portion of the adhesive printing material.

8. An adhesive printing material assembly as recited in claim 1, further comprising at least one additional adhesive printing material that is releasably affixed to the one side of the transport material.

9. An adhesive printing material assembly as recited in claim 1, wherein the adhesive printing material comprises a Post-it®.

10. An adhesive printing material assembly as recited in claim 9, wherein the Post-it® comprises a paper material.

11. An adhesive printing material assembly as recited in claim 1, wherein the adhesive printing material has a non-rectilinear shape.

12. An adhesive printing material assembly as recited in claim 1, wherein the adhesive printing material is positioned on the transport material in such a way that the adhesive printing material assembly is enabled to pass through a printing device, during a printing application, and without the adhesive printing material coming off of the transport material until the adhesive printing material is manually removed.

13. A method as recited in claim 1, wherein the adhesive portion comprises means for releasably adhering to a paper multiple times after being removed from the transport material.

14. A method for printing on an adhesive printing material assembly, the method comprising:
obtaining an adhesive printing material assembly comprising:
a transport material and an adhesive printing material that is releasably affixed to one side of the transport material, wherein the adhesive printing material comprises a first side and a second side, the first side including both an adhesive portion and a non-adhesive portion, wherein the adhesive portion comprises means for releasably adhering to the transport material and for being removed from the transport material without damaging the adhesive printing material or the transport material, and wherein the non-adhesive portion is free of any adhesive affixed thereto;
positioning the adhesive printing material assembly in a printing device to be printed on in such a way that the adhesive portion of the adhesive printing material enters the printing device prior to the non-adhesive portion;
providing printing instructions to the printing device that cause the printing device to print at least one of text and a graphic at a desired location on the adhesive printing material.

15. A method as recited in claim 14, wherein the transport material comprises a standard sheet of paper.

16. A method as recited in claim 15, wherein the method further includes removing the adhesive printing material from the paper, wherein upon removing the adhesive printing material, the paper comprises a blank and reusable paper for being printed on.

17. A method as recited in claim 14, wherein obtaining an adhesive printing material assembly includes obtaining the transport material and the adhesive printing material and assembling the adhesive printing material to the transport material.

18. A method as recited in claim 17, wherein the transport material includes a template printed thereon that corresponds specifically to one or more positions for placing the adhesive printing material to the transport material, and wherein assembling the adhesive printing material to the transport material includes placing the adhesive on the transport material according to the template.

19. A method as recited in claim 14, further including, providing the adhesive printing material assembly for sale after printing on the adhesive printing material.

20. A method as recited in claim 14, further including, removing the printed adhesive printing material after it is printed on and selling the adhesive printing material separately from the transport material.

21. A method as recited in claim 20, further including packaging the adhesive printing material with at least one publication, such that the adhesive printing material and the at least one publication are offered for sale together.

22. A method for facilitating the printing of an adhesive printing material, the method comprising:
providing a plurality of adhesive printing materials that are each releasably affixed to a single transport material as part of a single adhesive printing material assembly, the transport material comprising a piece of standard-sized paper, at least some of the adhesive printing materials being affixed to opposite sides of the single transport material;
wherein each of the adhesive printing materials comprises:
a first side and a second side, the first side including both an adhesive portion and a non-adhesive portion, wherein the adhesive portion comprises means for releasably adhering to the transport material and for being removed from the transport material without damaging the adhesive printing material or the transport material, and wherein the non-adhesive portion is free of any adhesive affixed thereto, and such that the adhesive printing material is releasably affixed to the transport material by the adhesive portion.

23. A method as recited in claim 22, wherein the paper comprises a blank piece of paper that is reusable for printing in a standard printing application after removing the plurality of adhesive printing materials and wherein the adhesive portion of each adhesive printing material is smaller in size than each corresponding non-3 adhesive portion.
